(19) United States
(12) Patent Application Publication
(10) Pub. No.: US 2025/0289271 A1
(43) Pub. Date: Sep. 18, 2025

(54) TIRE

(71) Applicant: Toyo Tire Corporation, Hyogo (JP)

(72) Inventor: Yuki TAKAGI, Hyogo (JP)

(73) Assignee: Toyo Tire Corporation, Hyogo (JP)

(21) Appl. No.: 19/062,213

(22) Filed: Feb. 25, 2025

(30) Foreign Application Priority Data
Mar. 14, 2024 (JP) 2024-039999

(51) Int. Cl. B60C 13/00; B29D 30/72

(52) U.S. Cl. CPC B60C 13/001; B29D 30/72; B29D 2030/726

(57) ABSTRACT

A tire includes a pattern region at least on a part of an outer surface of a sidewall of the tire, the pattern region being visually recognizable as being different from a perimeter of the part. The pattern region includes a plurality of projections projecting from a reference surface of the pattern region. Each of the plurality of projections includes a concavity that has an inverted conical or inverted pyramid inner surface, a conical barrel portion that forms an outer periphery of the projection and extends in a conical shape in a direction in which the projection projects from the reference surface, and an outer edge portion surrounding a circumference of the concavity. Each of the projections has a height of 0.6 mm or greater and 1.4 mm or less, and the concavity has a depth within a range of 30% to 70% of the projection height.

This application is based on and claims the benefit of priority from Japanese Patent Application No. 2024-039999, filed on 14 Mar. 2024, the content of which is incorporated herein by reference.

### FIELD

The present disclosure relates to a tire having, at least on a part of an outer surface of a sidewall, a pattern region for displaying a mark, a pattern, and the like, for example.

### BACKGROUND

There is a known tire having, on a part of a sidewall, a pattern region in which a large number of fine projections are aggregated (for example, Japanese Unexamined Patent Application, Publication No. 2020-131904). Such a pattern region, in which incident light is repeatedly reflected between the projections, has a light absorption effect, and consequently, the pattern region is visually recognized to be blacker than the outer surface of the sidewall around the pattern region, whereby the contrast is enhanced. Provision of this type of pattern region contributes to improving the design effect and appearance of the tire.

### SUMMARY

However, the tire disclosed in Japanese Unexamined Patent Application, Publication No. 2020-131904 has a complicated structure in which micro-protrusions are arranged in lattice-shaped parts defined by rib-shaped protrusions, and the manufacture of the tire involves considerable difficulty. Therefore, there is a possibility that the tire cannot be molded into a desired shape and the appearance may rather deteriorate.

It is an object of the present disclosure to provide a tire that has a higher black color intensity and a higher contrast than the known art and that is excellent in moldability.

A tire according to an aspect of the present disclosure includes a pattern region at least on a part of an outer surface of a sidewall of the tire, the pattern region being visually recognizable as being different from a perimeter of the part. The pattern region includes a plurality of projections projecting from a reference surface of the pattern region. Each of the plurality of projections includes a concavity that has an inverted conical or inverted pyramid inner surface, a conical barrel portion that forms an outer periphery of the projection and extends in a conical shape in a direction in which the projection projects from the reference surface, and an outer edge portion surrounding a circumference of the concavity. Each of the plurality of projections has a projection height of 0.6 mm or greater and 1.4 mm or less, and the concavity has a depth within a range of 30% or greater and 70% or less of the projection height.

The present disclosure makes it possible to provide a tire that has a higher black color intensity and a higher contrast than the known art and that is excellent in moldability.

### BRIEF DESCRIPTION OF THE DRAWINGS

FIG. 1 is a side view of a tire 1 according to a first embodiment;

FIG. 2 illustrates an example of a tire mold for vulcanization molding the tire 1 of the embodiment;

FIG. 3 is a perspective view illustrating a plurality of projections 110 arranged in a pattern region 7;

FIG. 4 is a plan view illustrating the plurality of projections 110 arranged in the pattern region 7, as viewed along the arrow T in FIG. 3;

FIG. 5 is a cross-sectional view of one of the plurality of projections 110 arranged in the pattern region 7, taken along the line indicated by the arrows A in FIG. 4; and

FIG. 6 is a cross-sectional view illustrating an example in which an outer edge portion 113 is configured as a flat plane; and

FIG. 7 is a table summarizing experimental results.

### DETAILED DESCRIPTION OF THE EMBODIMENTS

The following describes an embodiment of the present disclosure with reference to the drawings and the like.

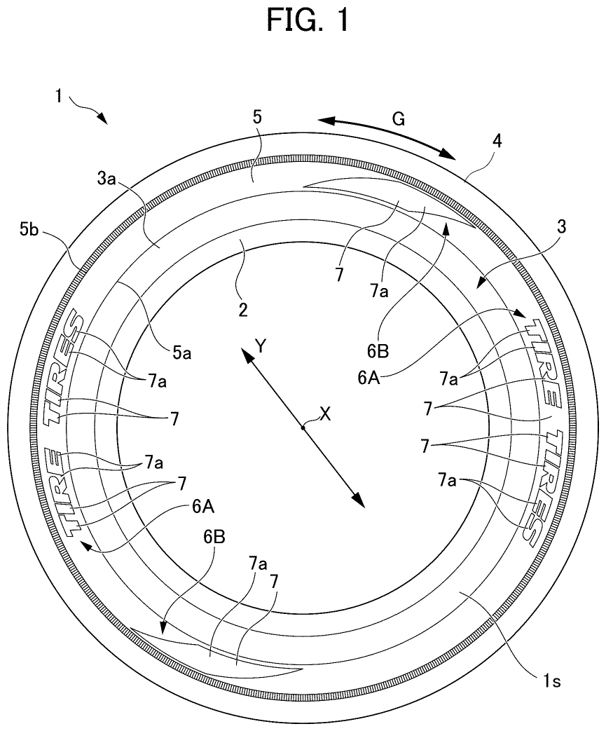

Hereinafter, the embodiment will be described with reference to the drawings. FIG. 1 is a side view of a tire 1 according to a first embodiment. The tire 1 is a so-called pneumatic tire that has an inner cavity filled with air at a predetermined pressure. The tire 1 of the embodiment is a pneumatic tire for passenger cars including light automobiles, SUVs, and the like. The configuration of the tire 1 of the embodiment can also be applied to pneumatic tires for other types of vehicles such as light trucks, trucks, and buses.

First, with reference to FIG. 1, an overview of a configuration mainly related to a side surface of the tire 1 will be described. FIG. 1 is a side view of the tire 1 viewed in the direction of a tire rotation axis X. The following description will be provided by referring to a tire axial direction, a tire circumferential direction, and a tire radial direction, which are as follows. The tire axial direction refers to a direction in which the tire rotation axis X extends, and corresponds to a front-back direction of the page of FIG. 1. The tire axial direction coincides with the left-right direction when the tire 1 is viewed in the tire radial direction, and therefore, the tire axial direction may be referred to as the left-right direction. The tire circumferential direction can be represented by an arc line centered on the tire rotation axis X, is a direction along the rotation direction of the tire 1, and is indicated by the arrow G in FIG. 1. The tire radial direction is a direction perpendicular to the tire rotation axis X, and is arbitrarily indicated by the arrow Y in FIG. 1.

As illustrated in FIG. 1, the tire 1 includes beads 2, sidewalls 3 that continue from the beads 2 and extend outward in the tire radial direction away from the tire rotation axis X, and a tread 4. One bead 2 and one sidewall 3 are provided on one side 1s of tire 1 illustrated in FIG. 1, and one bead 2 and one sidewall 3 are provided on the other side of the tire 1 spaced apart in the tire axial direction from the side 1s and not illustrated in FIG. 1. That is, the tire 1 includes the left and right beads 2 in pairs and the left and right sidewalls 3 in pairs. The tread 4 is disposed between the outer sides in the tire radial direction of the left and right sidewalls 3. The outer peripheral surface of the tread 4 includes a tread surface that contacts with a road surface.

The tire 1 is mainly composed of a plurality of types of rubbers respectively constituting the beads 2, the sidewalls 3, and the tread 4. A carcass ply that constitutes the skeleton of the tire 1 is disposed on an inner cavity-facing side of the rubber constituting the entire tire 1, and an inner liner that maintains an air pressure is disposed on an inner cavity-facing side of the carcass ply. An annular reinforcing belt is embedded in the rubber constituting the tread 4. The carcass ply, the inner liner, and the reinforcing belt are not illustrated. In addition to the foregoing components, various components are included as necessary in consideration of the function of the tire 1.

As illustrated in FIG. 1, the sidewall 3 has an outer surface 3a and an annular decorative region 5 extending on the outer surface 3a over the entire circumference in the tire circumferential direction. The decorative region 5 has a constant width and is defined between an inner arc line 5a and an outer arc line 5b. The inner arc line 5a is located inward in the tire radial direction and close to the tire rotation axis X in the tire radial direction, and the outer arc line 5b is located outward in the tire radial direction with respect to the inner arc line 5a. Each of the inner arc line 5a and the outer arc line 5b may be a line formed as a concavity, a convexity, or a step on the outer surface 3a of the sidewall 3, or may be a virtual line that does not actually exist.

On the outer surface 3a of the sidewall 3, the position of the decorative region 5 may be outside in the tire radial direction with respect to the position of a tire maximum width, or may be at a location including the position of the tire maximum width. The position of the tire maximum width refers to a position at which a length in the tire axial direction is maximized between the outer surfaces 3a of the left and right sidewalls 3.

The tire 1 includes pattern regions 7 on parts of the outer surface 3a of the sidewall 3. Each pattern region 7 is visually recognizable as being different from the perimeter of the part where the pattern region 7 is provided. Each pattern region 7 is provided on a sidewall rubber that is a black rubber member constituting the outer surface of the sidewall 3.

As illustrated in FIG. 1, mark portions 6A are provided on the annular decorative region 5 at two positions opposite to each other across the tire rotation axis X. Each mark portion 6A includes a plurality of characters arranged in the tire circumferential direction. By means of the plurality of characters, at least one of a manufacturer name, a product name, a brand mark, or the like is displayed. Each character may be bordered with a concave or convex line, or the entirety of each character may be formed of a concavity or convexity. For example, the characters of the mark portions 6A are provided as the pattern regions 7 of the embodiment.

As illustrated in FIG. 1, motif portions 6B are provided on the annular decorative region 5 at two positions each of which is sandwiched between the two mark portions 6A in the circumferential direction. Each motif portion 6B includes a motif like a parallelogram curved along the annular decorative region 5. For example, the motifs of the motif portions 6B are also provided as the pattern regions 7 of the embodiment.

It should be noted that the shapes of the pattern regions 7 are not limited to the foregoing shapes, and various shapes may be adopted, examples of which include an arbitrary shape, shapes delineating the above-mentioned manufacturer name, product name, brand mark, etc., and shapes delineating other numerals, characters, etc.

Each of the pattern regions 7 of the embodiment has a reference surface 7a extending along the profile of the sidewall 3. Each reference surface 7a has a plurality of projections 110 (to be described later) formed thereon. Due to the plurality of projections 110, each pattern region 7 is visually recognizable as being different from the perimeter of the pattern region 7. Each reference surface 7a may protrude outward in the tire axial direction from the profile of the sidewall 3, may be depressed inward in the tire axial direction from the profile of the sidewall 3, or may be located at the same position in the tire axial direction as the profile of the sidewall 3.

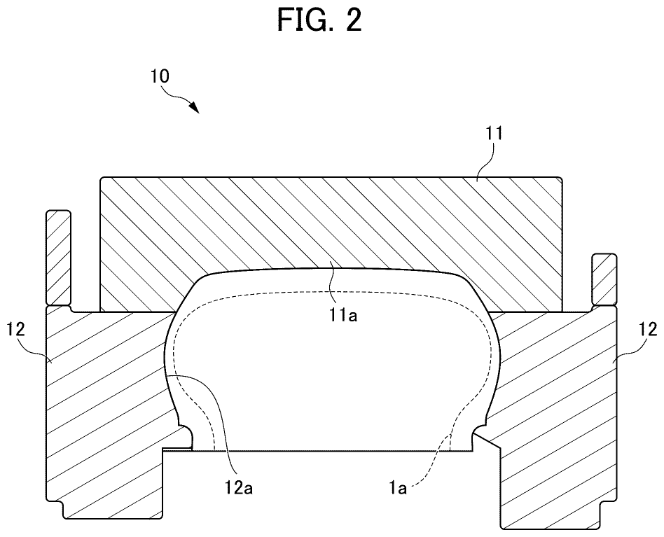

FIG. 2 illustrates an example of a tire mold for vulcanization molding the tire 1 of the embodiment. FIG. 2 is a meridian sectional view of the tire mold 10, taken along the axial direction of the tire 1 to be molded.

The tire mold 10 illustrated in FIG. 2 includes a plurality of sectors 11 arranged circumferentially along the outer circumference of the tire 1, a pair of side plates 12 disposed at both axial sides of an annular body formed by the plurality of sectors 11 combined with each other, and a pair of bead rings (not shown). At the time of vulcanization molding, an unvulcanized tire 1a to be molded into the tire 1 is set inside the tire mold 10, as indicated by the broken line in FIG. 2. The assembly of the sectors 11, the side plates 12, and the bead rings constitutes the mold for molding the tire 1, and the entire outer surface of the tire 1 is molded by the inner surface of the mold, namely, the inner surfaces 11a of the sectors 11, the inner surfaces 12a of the side plates 12, and the inner surfaces of the bead rings. During vulcanization molding, a bladder (not shown) that presses the unvulcanized tire 1a against the inner surface of the tire mold 10 is disposed inside the unvulcanized tire 1a. The plurality of sectors 11 mainly play a role in forming the tread 4, and the pair of side plates 12 mainly play a role in forming the sidewalls 3. The pair of bead rings play a role in forming the beads 2, and the bladder plays a role in forming the entire inner surface of the tire 1.

In the tire mold 10, the unvulcanized tire 1a is vulcanized so that the rubbers constituting the entire tire 1 are shaped, and the plurality of projections 110 described below are formed in the pattern regions 7 described above.

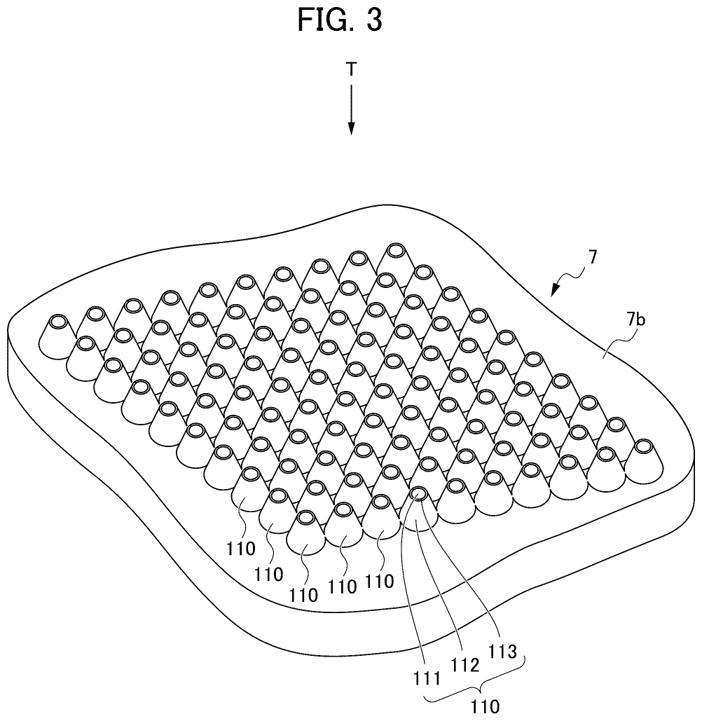

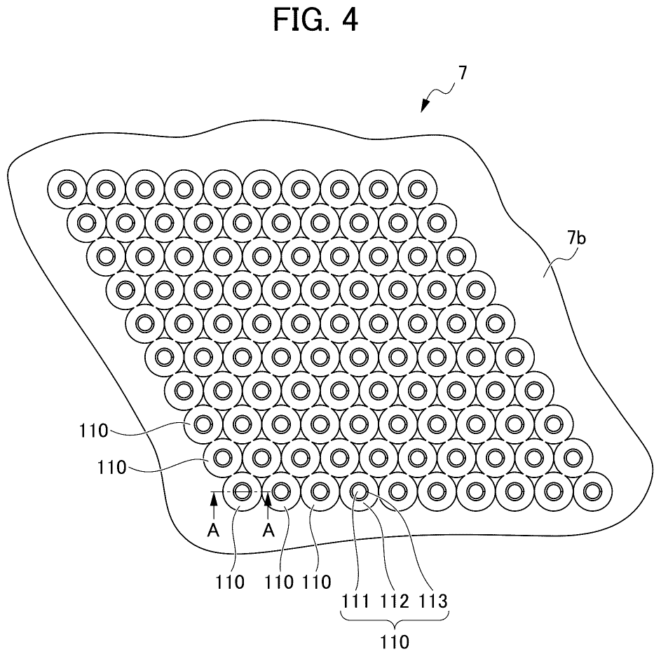

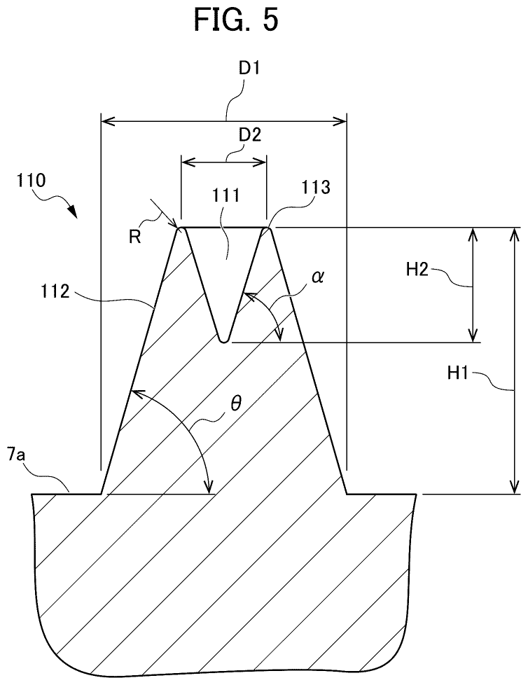

FIG. 3 is a perspective view illustrating the plurality of projections 110 arranged in the pattern region 7. FIG. 4 is a plan view illustrating the plurality of projections 110 arranged in the pattern region 7, as viewed along the arrow T in FIG. 3. FIG. 5 is a cross-sectional view of one of the plurality of projections 110 arranged in the pattern region 7, taken along the line indicated by the arrows A in FIG. 4. While the plurality of projections 110 are arranged in, and project from, the reference surface 7a of the pattern region 7, FIGS. 3 to 5 illustrate a state in which the plurality of projections 110 are arranged on, and project from, a UV unwrapping reference surface 7b that results from UV unwrapping the reference surface 7a of the pattern region 7. FIG. 5 illustrate only one projection 110 in a cross section. The UV unwrapping reference surface 7b is a surface resulting from two-dimensionally unwrapping the three-dimensional outer surface 3a of the sidewall 3.

The plurality of projections 110 are arranged in an array and project outwardly from the reference surface 7a substantially in the tire axial direction. As illustrated in FIG. 4, the projections 110 of the present embodiment are regularly arranged in a plurality of rows. Specifically, the projections 110 are arranged in contact with each other at equal pitches in each row, so that a close-packing arrangement in which the positions of the projections 110 are shifted by a half pitch between the adjacent rows is achieved. However, the arrangement of the projections 110 is not limited to the close-packing arrangement. For example, the projections 110 may be arranged at predetermined intervals without being in contact with each other, or may be arranged randomly to an extent that a predetermined arrangement density can be maintained. Each projection 110 has the concavity 111, a conical barrel portion 112, and an outer edge portion 113.

The concavity 111 is located at the center of the projection 110 when the projection 110 is viewed from above (in the direction of the arrow T in FIG. 3), and has a mortar-shaped inner surface (an inverted conical or inverted pyramid inner surface). The concavity 111 has a bottom formed into a minute curved plane that constitutes a substantially hemispherical inner surface. It should be noted that the term “mortar-shaped” as used herein means not only an inverted conical shape but also an inverted pyramid shape such as an inverted triangular pyramid shape, an inverted quadrangular pyramid shape, and analogous shapes.

The conical barrel portion 112 constitutes the outer periphery of the projection 110. The conical barrel portion 112 has a conical shape and extends in a direction in which the projection 110 projects from the reference surface 7a. Here, the term “conical” refers to a divergent shape like a conical surface, for example. It is preferable that, in the cross-sectional shape illustrated in FIG. 5, which is orthogonal to the reference surface 7a, the inclined surface of the conical barrel portion 112 and the inclined surface of the concavity 111 are symmetrical to each other, as in the projections 110 of the present embodiment. Here, the configuration in which the inclined surface of the conical barrel portion 112 and the inclined surface of the concavity 111 are symmetrical to each other means that the inclined surfaces are axisymmetric to each other in the cross-sectional shape illustrated in FIG. 5. Therefore, when an angle formed by the inclined surface of the conical barrel portion 112 and the reference surface 7a is defined as θ and an angle formed by the inclined surface of the concavity 111 and the reference surface 7a is defined as α, the relationship described as θ=α is satisfied. Satisfying this relationship allows the conical barrel portion 112 and the concavity 111 to reflect light at the substantially same angle, so that an optical design including absorption of light can be easily developed, and a uniform light absorption effect can be achieved.

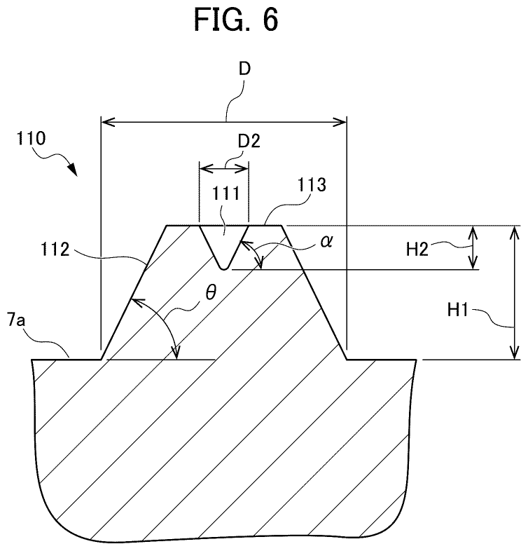

The outer edge portion 113 surrounds a circumference of the concavity 111, and forms the leading end of the projection 110. More specifically, the outer edge portion 113 has a curved surface that surrounds an opening of the concavity 111. The opening of the concavity 111 is the boundary between the outer edge portion 113 and the inclined surface of the concavity 111. In the example illustrated in FIG. 5, the opening of the concavity 111 constitutes a curve where the curved surface of the outer edge portion 113 intersects with the inclined surface of the concavity 111. In the case of the modification illustrated in FIG. 6, the opening of the concavity 111 constitutes a curve where the flat surface of the outer edge portion 113 intersects with the inclined surface of the concavity 111. In the example illustrated in FIG. 5, the outer edge portion 113 has the shape of a curved plane that smoothly connects the inclined surface of the concavity 111 and the inclined surface of the conical barrel portion 112. For example, in the cross section illustrated in FIG. 5, the outer edge portion 113 can be configured by smoothly connecting the inclined surface of the concavity 111 and the inclined surface of the conical barrel portion 112 such that a radius of curvature R nearly equal to 0.01 mm.

The outer edge portion 113 is not limited to the curved plane, and may be configured as a flat plane. FIG. 6 is a cross-sectional view illustrating an example in which the outer edge portion 113 is configured as a flat plane. As illustrated in FIG. 6, the outer edge portion 113 may be configured as a flat plane parallel to the reference surface 7a, for example.

A part of light that has reached the concavity 111 of each projection 110 is reflected by the inclined surface of the concavity 111, and the reflected light is further reflected repeatedly inside the same concavity 111. Such repetition of reflection of light occurs in the concavity 111, so that the light that has reached the concavity 111 is gradually attenuated and absorbed. A part of light that has reached the conical barrel portion 112 of each projection 110 is reflected by the inclined surface of the conical barrel portion 112, and a part of the reflected light reaches the conical barrel portion 112 of a proximal projection 110 and is reflected. The reflection of light is repeated in this way. The reflection of light is repeated between the conical barrel portions 112 of the plurality of projections 110, whereby the light that has reached the conical barrel portions 112 is gradually attenuated and absorbed. Thus, since a part of light incident on each pattern region 7 in which the plurality of projections 110 are arranged is absorbed and prevented from exiting to the outside, the pattern regions 7 having the projections 110 provided therein are visually recognized as being blacker than the outer surface 3a of the sidewall 3 that surrounds the pattern regions 7 and reflects light.

Here, the effect of light absorption varies depending on the dimensions of the portions of the projection 110. It is necessary to achieve not only the effect of light absorption but also stability of manufacturing in the manufacturing process. Since the projections 110 are formed of repletion of minute shapes, the projections 110 may not be stably molded into a desired shape. In consideration of these issues, a plurality of test pieces provided with the projections 110 the portions of which had different shapes and different dimensions were prepared and subjected to an experiment to verify light absorbability and molding accuracy.

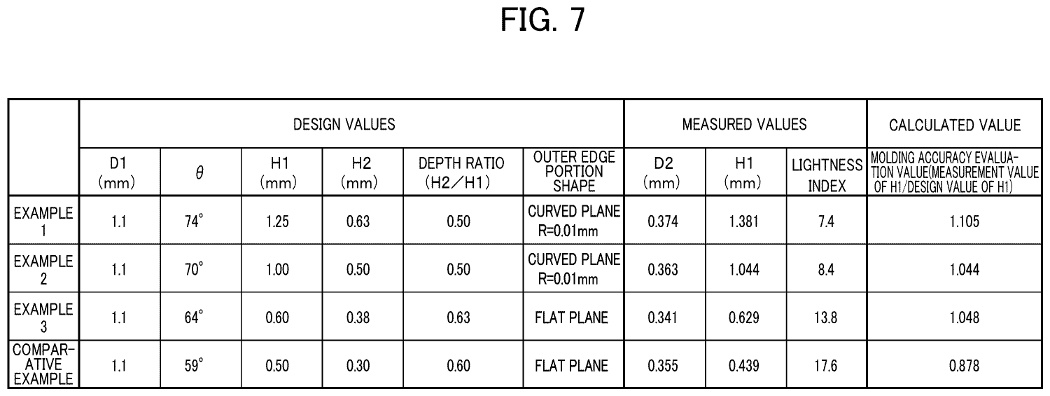

FIG. 7 is a table summarizing the experimental results. As illustrated in FIGS. 5 to 7, the maximum outer diameter of the projection 110 is denoted by D1, the maximum inner diameter of the concavity 111 is denoted by D2, the height of the projection 110 from the reference surface 7a is denoted by H1, and the depth of the concavity 111 is denoted by H2. The angle formed by the inclined surface of the conical barrel portion 112 and the reference surface 7a in the cross sections illustrated in FIGS. 5 and 6 is denoted by θ. In the experiment, the respective test pieces of Examples 1 to 3 and Comparative Example were prepared and compared. The design values, measured values, and the like of the respective test pieces are shown in FIG. 7. FIG. 7 further shows a ratio of the depth H2 of the concavity 111 to the height H1 of the projection 110 (H2/H1) as a depth ratio.

Furthermore, FIG. 7 shows measured values of D2 and H1 and lightness indexes. The lightness indexes were measured using a color reader CR-20 manufactured by KONICA MINOLTA JAPAN, INC. Each test piece was sized to cover the measurement port (φ8 mm). The observation light source was D65, and L component values in the L*a*b* display system (color space) were taken as the lightness indexes. Since a region is visually recognized to be blacker (has a higher black color intensity and a higher contrast) as the lightness index decreases, it is desirable that the lightness index be as small as possible in order to achieve the object of the present embodiment, namely, the object to make a region be visually perceivable as blacker. Specifically, in order to achieve an effect that a region is visually perceived as blacker, the lightness index is preferably 15 or less, and more preferably 10 or less.

Furthermore, FIG. 7 shows molding accuracy evaluation values. The molding accuracy evaluation value is obtained by dividing a measurement value of H1 by a design value of H1. The closer the molding accuracy evaluation value is to 1.00, the higher the molding accuracy, and the molding accuracy evaluation value is preferably 0.85 or greater and 1.15 or less.

As shown in FIG. 7, Examples 1 to 3 and Comparative Example have a molding accuracy evaluation value in the range of 0.85 or greater and 1.15 or less, which indicates a good moldability. On the other hand, Comparative Example has a lightness index of 17.6, and is not sufficiently effective in making a region visually perceived as blacker. Examples 1 and 2 each have a lightness index smaller than 9.0, and is highly effective in making a region visually perceived as blacker. These results indicates that the projection height H1 of the projection 110 is preferably 0.6 mm or greater and 1.4 mm or less, and more preferably 1.0 mm or greater and 1.3 mm or less. The depth of the concavity 111 is preferably 30% or greater and 70% or less of the projection height H1 of the projection 110 (the depth ratio is preferably 0.3 or greater and 0.7 or less).

It would be further desirable that the shape of each outer edge portion 113 be a curved plane rather than a flat plane. This is because the outer edge portion 113 configured as a flat plane reflects a large amount of light in the same direction, whereby the effect that the region is visually perceived as blacker deteriorates. In a case where the curved plane of the outer edge portion 113 has a large radius of curvature, the effect that the region is visually perceived as blacker would adversely deteriorate as in the case where the outer edge portion 113 has a flat plane. Therefore, it is desirable that the curved plane of the outer edge portion 113 has a small radius of curvature R, which is preferably 0.02 mm or less, more preferably 0.01 mm or less.

Furthermore, the angle θ formed by the inclined surface of the conical barrel portion 112 and the reference surface 7a is preferably 60° or greater and 80° or less, and more preferably 65° or greater and 75° or less.

The tire 1 according to the present embodiment described above exerts the following effects.

(1) A tire 1 according to the present embodiment includes: a pattern region 7 at least on a part of an outer surface of a sidewall 3 of the tire 1, the pattern region 7 being visually recognizable as being different from a perimeter of the part, the pattern region 7 includes a plurality of projections 110 projecting from a reference surface 7a of the pattern region 7, each of the plurality of projections 110 has a concavity 111 that has an inverted conical or inverted pyramid inner surface, a conical barrel portion 112 that forms an outer periphery of the projection 110 and extends in a conical shape in a direction in which the projection 110 projects from the reference surface 7a, and an outer edge portion 113 surrounding a circumference of the concavity 111, the projection 110 has a projection height of 0.6 mm or greater and 1.4 mm or less, and the concavity 111 has a depth within the range of 30% or greater and 70% or less of the projection height of the projection 110.

This feature makes it possible to provide a tire that has a higher black color intensity and a higher contrast than the known art, and is excellent in moldability.

(2) In the tire 1 according to (1), the outer edge portion 113 has the shape of a curved plane that smoothly connects an inclined surface of the concavity 111 and an inclined surface of the conical barrel portion 112.

This feature makes it possible to further enhance the effect of achieving a higher black color intensity and a higher contrast. In addition, due to this feature a change that occurs in degree of reflection of light depending on the viewing angle can be reduced to a low level, whereby a change in degree of blackness (lightness) can be reduced.

(3) In the tire 1 according to (2), the outer edge portion 113 has a radius of curvature of 0.02 mm or less.

This feature makes it possible to further enhance the effect of achieving a higher black color intensity and a higher contrast.

(4) In the tire 1 according to (1) or (2), the conical barrel portion 112 is inclined with respect to the reference surface 7a at an inclination angle of 60° or greater and 80° or less.

This feature makes it possible to further enhance the effect of achieving a higher black color intensity and a higher contrast.

(5) In the tire 1 according to (1) or (2), an inclined surface of the conical barrel portion 112 and an inclined surface of the concavity 111 are symmetrical to each other in a cross-sectional shape of each of the plurality of projections 110, the cross-sectional shape being orthogonal to the reference surface 7a.

Due to this feature, an optical design including absorption of light can be easily developed, and a uniform light absorption effect can be achieved.

### Modifications

The present disclosure is not limited to the embodiment described above, and various modifications and changes can be made, which are also encompassed in the scope of the present disclosure.

### Modification 1

The above embodiment has been described with reference to an example in which the inclined surface of each conical barrel portion 112 and the inclined surface of each concavity 111 are both conical surfaces. This is a non-limiting example, and at least one of the inclined surface of each conical barrel portion 112 or the inclined surface of each concavity 111 may be a pyramid surface such as a quadrangular pyramid surface, a triangular pyramid surface, or the like.

### Modification 2

The above embodiment has been described with reference to an example in which the outer edge portion 113 is configured as a curved plane whose radius of curvature is constant in cross section. This is a non-limiting example, and the outer edge portion 113 may have a shape resulting from a combination of a plurality of different curved planes.

Although the embodiments and the modifications may be combined with each other as appropriate, detailed description of such combinations are omitted. It should be noted that the present disclosure is not limited to the embodiments described above.

What is claimed is:

1. A tire comprising:
a pattern region at least on a part of an outer surface of a sidewall of the tire, the pattern region being visually recognizable as being different from a perimeter of the part,
the pattern region comprising a plurality of projections projecting from a reference surface of the pattern region,
each of the plurality of projections comprising:
a concavity that has an inverted conical or inverted pyramid inner surface,
a conical barrel portion that forms an outer periphery of the projection and extends in a conical shape in a direction in which the projection projects from the reference surface, and
an outer edge portion surrounding a circumference of the concavity,
each of the plurality of projections having a projection height of 0.6 mm or greater and 1.4 mm or less, and
the concavity having a depth within a range of 30% or greater and 70% or less of the projection height.

2. The tire according to claim 1, wherein
the outer edge portion has a shape of a curved plane that smoothly connects an inclined surface of the concavity and an inclined surface of the conical barrel portion.

3. The tire according to claim 2, wherein
the outer edge portion has a radius of curvature of 0.02 mm or less.

4. The tire according to claim 1, wherein
the conical barrel portion is inclined with respect to the reference surface at an inclination angle of 60° or greater and 80° or less.

5. The tire according to claim 2, wherein
the conical barrel portion is inclined with respect to the reference surface at an inclination angle of 60° or greater and 80° or less.

6. The tire according to claim 1, wherein
an inclined surface of the conical barrel portion and an inclined surface of the concavity are symmetrical to each other in a cross-sectional shape of each of the plurality of projections, and the cross-sectional shape is orthogonal to the reference surface.

7. The tire according to claim 2, wherein
an inclined surface of the conical barrel portion and an inclined surface of the concavity are symmetrical to each other in a cross-sectional shape of each of the plurality of projections, and the cross-sectional shape is orthogonal to the reference surface.
